(19) United States
(12) Patent Application Publication
(10) Pub. No.: US 2024/0320555 A1
(43) Pub. Date: Sep. 26, 2024

(54) INFORMATION PROCESSING APPARATUS, INFORMATION PROCESSING METHOD, AND NON-TRANSITORY COMPUTER READABLE MEDIUM

(71) Applicant: TOYOTA JIDOSHA KABUSHIKI KAISHA, Toyota-shi (JP)

(72) Inventors: Lukas FRANNEK, Tokyo-to (JP); Narimasa WATANABE, Tokyo-to (JP)

(73) Assignee: TOYOTA JIDOSHA KABUSHIKI KAISHA, Toyota-shi (JP)

(21) Appl. No.: 18/594,251

(22) Filed: Mar. 4, 2024

(30) Foreign Application Priority Data
Mar. 24, 2023 (JP) 2023-048999

(51) Int. Cl. G06N 20/00

(52) U.S. Cl. CPC G06N 20/00

(57) ABSTRACT

An information processing apparatus includes a controller. The controller is configured to execute operations that include collecting behavior-related information regarding the behavior of one or more humans in a certain geographic area, extracting a human parameter from the behavior-related information, training a model using the human parameter, generating one or more virtual humans using the model, measuring the behavior of the one or more virtual humans in the geographic area, and determining, from the measured behavior, a service content in the geographic area.

### CROSS-REFERENCE TO RELATED APPLICATION

This application claims priority to Japanese Patent Application No. 2023-048999, filed on Mar. 24, 2023, the entire contents of which are incorporated herein by reference.

### TECHNICAL FIELD

The present disclosure relates to an information processing apparatus, an information processing method, and a program.

### BACKGROUND

Technology for acquiring personality diagnosis data based on sensing data obtained by sensing the behavior of a user and selecting, as a virtual human, a character with personality that matches the acquired personality diagnosis data is known. For example, see Patent Literature (PTL) 1.

### CITATION LIST

### Patent Literature

PTL 1: JP 2020-160641 A

### SUMMARY

There is room for further utilizing personality diagnosis data of the above technology, which is acquired based on sensing data.

It would be helpful to increase the quality of life (QOL) in a certain geographic area while protecting the privacy of real humans by generating and observing virtual humans, without directly observing the real humans, and determining a service content.

An information processing apparatus according to an embodiment of the present disclosure is an information processing apparatus including a controller configured to execute operations, the operations including:
collecting behavior-related information regarding behavior of one or more humans in a certain geographic area;
extracting a human parameter from the behavior-related information;
training a model using the human parameter;
generating one or more virtual humans using the model;
measuring behavior of the one or more virtual humans in the geographic area; and
determining, from the measured behavior, a service content in the geographic area.

An information processing method according to an embodiment of the present disclosure is an information processing method by an information processing apparatus, the information processing method including:
collecting behavior-related information regarding behavior of one or more humans in a certain geographic area;
extracting a human parameter from the behavior-related information;
training a model using the human parameter;
generating one or more virtual humans using the model;
measuring behavior of the one or more virtual humans in the geographic area; and
determining, from the measured behavior, a service content in the geographic area.

A program according to an embodiment of the present disclosure is a program configured to cause a computer to function as the information processing apparatus.

An embodiment of the present disclosure can increase the quality of life in a certain geographic area while protecting the privacy of real humans.

### BRIEF DESCRIPTION OF THE DRAWINGS

In the accompanying drawings:

FIG. 1 is a schematic diagram of an information processing system;

FIG. 2 is a block diagram illustrating a configuration of an information processing apparatus;

FIG. 3 is a block diagram illustrating a configuration of a user terminal;

FIG. 4 is a diagram illustrating a data structure of a virtual human database; and

FIG. 5 is a flowchart illustrating operations of the information processing apparatus.

### DETAILED DESCRIPTION

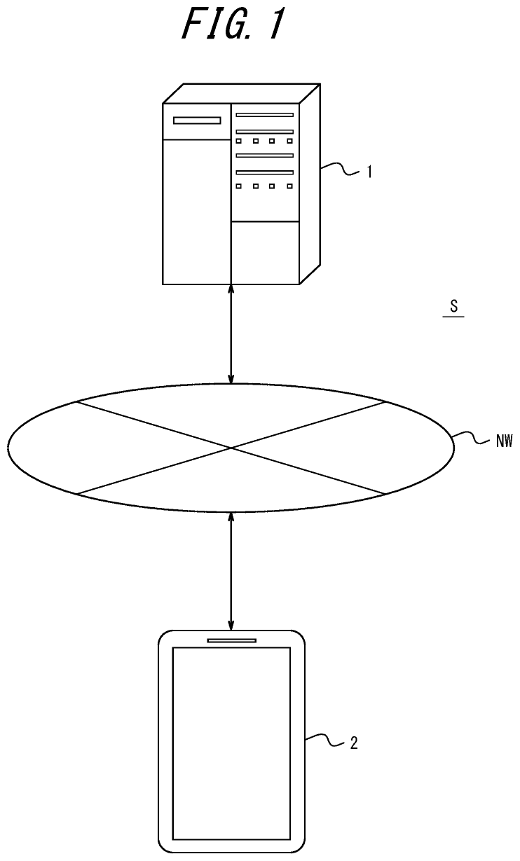

FIG. 1 is a schematic diagram of an information processing system S according to the present embodiment. The information processing system S includes an information processing apparatus 1 and a user terminal 2, which are communicably connected to each other via a network NW. The network NW includes, for example, a mobile communication network, a fixed communication network, or the Internet.

FIG. 1 illustrates one of the information processing apparatus 1 and one of the user terminal 2, for convenience of explanation. However, the number of information processing apparatuses 1 and the number of user terminals 2 are not limited to one. For example, processing to be executed by the information processing apparatus 1 according to the present embodiment may be executed by a plurality of distributed information processing apparatuses 1.

The information processing apparatus 1 is installed in a facility such as a data center. The information processing apparatus 1 is a computer such as a server that belongs to a cloud computing system or another type of computing system.

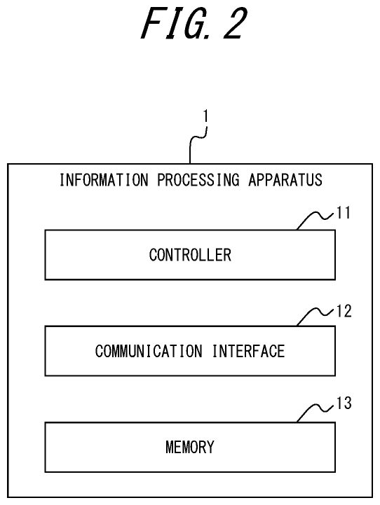

With reference to FIG. 2, an internal configuration of the information processing apparatus 1 will be described in detail.

The information processing apparatus 1 includes a controller 11, a communication interface 12, and a memory 13. The components of the information processing apparatus 1 are communicably connected to one another via, for example, dedicated lines.

The controller 11 includes, for example, one or more general purpose processors including a Central Processing Unit (CPU) or a Micro Processing Unit (MPU). The controller 11 may include one or more dedicated processors that are dedicated to specific processing. The controller 11 may include one or more dedicated circuits instead of the processors. Examples of the dedicated circuits may include a Field-Programmable Gate Array (FPGA) and an Application Specific Integrated Circuit (ASIC). The controller 11 may include an Electronic Control Unit (ECU). The controller 11 transmits and receives any information via the communication interface 12.

The communication interface 12 includes a communication module for connecting to the network NW. The communication interface 12 may include a module conforming to one or more mobile communication standards including the Long Term Evolution (LTE) standard, the 4th Generation (4G) standard, or the 5th Generation (5G) standard. The communication interface 12 may include one or more communication modules conforming to near field communication standards or specifications, including Bluetooth® (Bluetooth is a registered trademark in Japan, other countries, or both), AirDrop® (AirDrop is a registered trademark in Japan, other countries, or both), IrDA, ZigBee® (ZigBee is a registered trademark in Japan, other countries, or both), Felica® (Felica is a registered trademark in Japan, other countries, or both), or RFID. The communication interface 12 transmits and receives any information via the network NW.

The memory 13 includes, for example, a semiconductor memory, a magnetic memory, an optical memory, or a combination of at least two of these, but is not limited to these. The semiconductor memory is, for example, RAM or ROM. The RAM is, for example, SRAM or DRAM. The ROM is, for example, EEPROM. The memory 13 may function as, for example, a main memory, an auxiliary memory, or a cache memory. The memory 13 may store information resulting from analysis or processing performed by the controller 11. The memory 13 may store various types of information or the like regarding operations and control of the information processing apparatus 1. The memory 13 may store a system program, an application program, embedded software, and the like. The memory 13 may be provided outside the information processing apparatus 1 and accessed by the information processing apparatus 1. The memory 13 includes a vehicle human database.

The user terminal 2 is, for example, a mobile device such as a mobile phone, a smartphone, a wearable device, or a tablet. As an alternative example, the user terminal 2 may be a general purpose device such as a PC, or a dedicated device. The term “PC” is an abbreviation of personal computer.

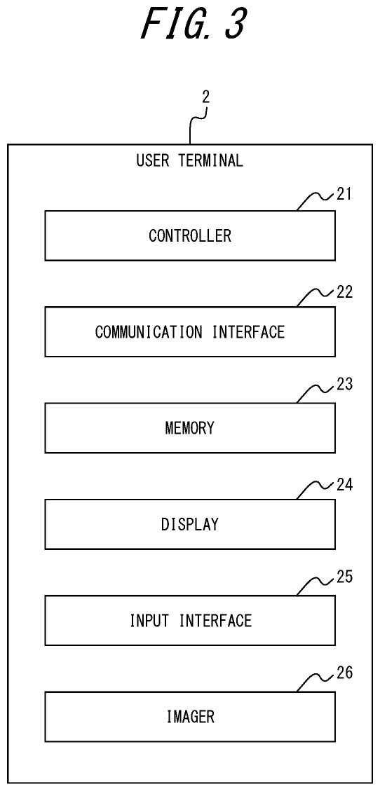

With reference to FIG. 3, an internal configuration of the user terminal 2 will be described in detail.

The user terminal 2 includes a controller 21, a communication interface 22, a memory 23, a display 24, an input interface 25, and an imager 26. The components of the user terminal 2 are communicably connected to one another, for example, via dedicated lines.

Descriptions of the hardware configurations of the controller 21, the communication interface 22, and the memory 23 of the user terminal 2 may be the same as the descriptions of the hardware configurations of the controller 11, the communication interface 12, and the memory 13 of the information processing apparatus 1, respectively. A description here is omitted.

The display 24 is, for example, a display. The display is, for example, an LCD or an organic EL display. The term “LCD” is an abbreviation of liquid crystal display. The term “EL” is an abbreviation of electro luminescence. The display 24, instead of being included in the user terminal 2, may be connected to the user terminal 2 as an external output device. As a connection method, for example, any technology such as USB, HDMI® (HDMI is a registered trademark in Japan, other countries, or both), or Bluetooth® can be used.

The input interface 25 is, for example, a physical key, a capacitive key, a pointing device, a touch screen integrally provided with a display, or a microphone. The input interface 25 accepts an operation for inputting information to be used for operations of the user terminal 2. The input interface 25, instead of being included in the user terminal 2, may be connected to the user terminal 2 as an external input device. As a connection method, for example, any technology such as USB, HDMI®, or Bluetooth® can be used. The term “USB” is an abbreviation of Universal Serial Bus. The term “HDMI®” is an abbreviation of High-Definition Multimedia Interface.

The imager 26 includes a camera. The imager 26 can capture images of its surroundings. The imager 26 may store the captured images in the memory 23 or transmit the captured images to the controller 21 for the purpose of image analysis. The images include still images or moving images.

An outline of processing executed by the information processing apparatus 1 of the present embodiment will be described. The controller 11 executes operations that include collecting behavior-related information regarding the behavior of one or more humans in a certain geographic area, extracting a human parameter from the behavior-related information, training a model using the human parameter, generating one or more virtual humans using the model, measuring the behavior of the one or more virtual humans in the geographic area, and determining, from the measured behavior, a service content in the geographic area. With this configuration, the information processing apparatus 1 can increase the quality of life in the certain geographic area while protecting the privacy of the real humans by generating and observing the virtual humans, without directly observing the real humans, and determining the service content.

Hereinafter, an information processing method to be executed by an information processing system S will be described in detail.

The controller 11 of the information processing apparatus 1 collects behavior-related information regarding the behavior (human behavior) of one or more humans in a certain geographic area. The certain geographic area may be determined arbitrarily. The number of certain geographic areas is arbitrary. The humans in the certain geographic area may be residents of the geographic area or humans who are present in the geographic area at a given time. The behavior-related information includes, for example, at least one of the following:
Psychographic data
Demographic data
Calendar
Health data
Exercise frequency
Purchase pattern
Accompanying human
Family structure

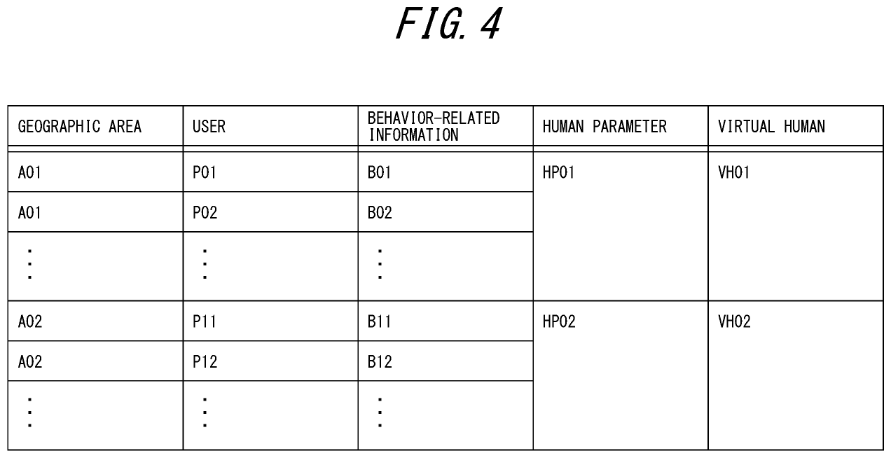

The behavior-related information is collected from the user terminals 2 or any database. As illustrated in FIG. 4, the controller 11 stores user identification information and the behavior-related information in association with geographic area identification information.

The controller 11 extracts a human parameter from the behavior-related information. As illustrated in FIG. 4, the controller 11 stores the human parameter in association with the behavior-related information. Any algorithm may be used for the extraction. The human parameter may include, for example, at least one of the following:
Personality
Likes/Dislikes
Sense of values
Activeness
Sociability
Hobby

The controller 11 trains a model using the human parameter. The model may be, for example, a Tabular Variational AutoEncoder (TVAE) model.

The controller 11 generates one or more virtual humans using the model. As illustrated in FIG. 4, the controller 11 stores the virtual humans in association with the human parameter. Any algorithm may be used for the generation. In the example of FIG. 4, one virtual human is generated per geographic area. As an alternative example, the controller 11 may divide one geographic area into multiple small areas and generate one virtual human per small area.

The controller 11 measures the behavior (stimulated behavior) of the one or more virtual humans in the geographic area. Any algorithm may be used for the measurement.

The controller 11 determines, from the measured behavior, a service content in the geographic area. The service content may include, for example, at least one of the following:
Transportation
Educational Content
Restaurant Guide
Meal Service
Event

The determination of the service content may be performed with reference to a table in which the behavior and the service content are in association with each other.

As an additional or alternative example, the service content determined in the geographic area may relate to take-out products. In this case, the service content includes at least one of the following:
Restaurant menu
Number of advertisements
Production volume of take-out products

As an additional or alternative example, the service content determined in the geographic area may relate to a mobile service. In this case, the service content includes a mobile route or the number of humans to be accommodated by the mobile service.

As an additional or alternative example, the service content determined in the geographic area may relate to an event. In this case, the service content includes an event feature, an advertisement, a start time, or an incentive.

As an additional example, the controller 11 performs, for a second geographic area, the same process as for the certain geographic area (hereinafter also referred to as “first geographic area”). For convenience of explanation, duplicate descriptions are omitted here. The controller 11 measures the behavior of one or more virtual humans in the second geographic area. The controller 11 can make a comparison between the behavior of the virtual humans in the first geographic area and the behavior of the virtual humans in the second geographic area, and generate a comparison result. The controller 11 may determine, from the comparison result, a service content, a population trend, and/or the number of virtual humans in each of the geographic areas. The determination may be performed with reference to a table that stores a correspondence with the comparison result.

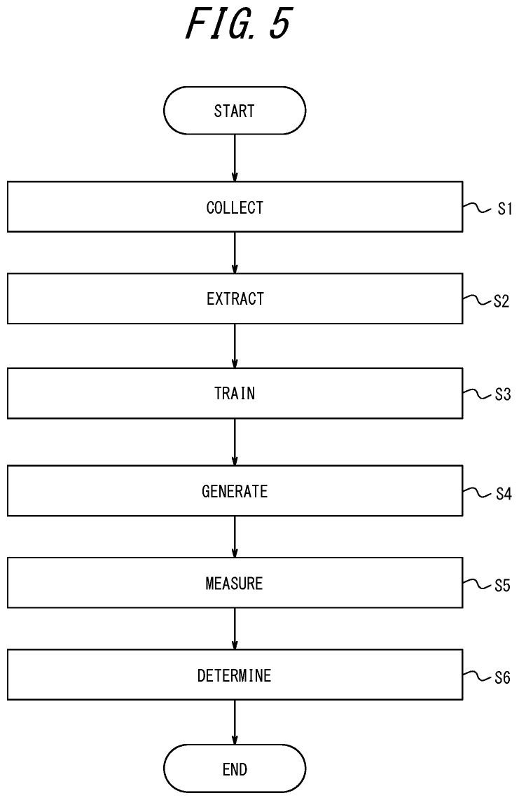

An information processing method by the information processing apparatus 1 will be described with reference to FIG. 5.

In step S1, the controller 11 collects behavior-related information regarding the behavior of one or more humans in a certain geographic area at any given time. In step S2, the controller 11 extracts a human parameter from the behavior-related information. In step S3, the controller 11 trains a model using the human parameter. In step S4, the controller 11 generates one or more virtual humans using the model.

In step S5, the controller 11 measures the behavior of the one or more virtual humans in the geographic area. In step S6, the controller 11 determines, from the measured behavior, a service content in the geographic area.

According to the present embodiment, as described above, the controller 11 executes the operations that include collecting the behavior-related information regarding the behavior of the one or more humans in the certain geographic area, extracting the human parameter from the behavior-related information, training the model using the human parameter, generating the one or more virtual humans using the model, measuring the behavior of the one or more virtual humans in the geographic area, and determining, from the measured behavior, the service content in the geographic area. With this configuration, the information processing apparatus 1 can increase the quality of life in the certain geographic area while protecting the privacy of the real humans by generating and observing the virtual humans, without directly observing the real humans, and determining the service content.

According to the present embodiment, the behavior-related information includes psychographic data, demographic data, calendar, health data, an exercise frequency, a purchase pattern, an accompanying human, and/or a family structure. The human parameter includes personality, likes/dislikes, a sense of values, activeness, sociability, and/or a hobby. The service content relates to transportation, an educational content, a restaurant guide, a meal service, and/or an event. With this configuration, the information processing apparatus 1 can determine the precise service content with high accuracy. For example, a mobile service provider can optimize movement and thereby provide the residents of the geographic area with better routes and lower congestion. For example, an event planner can optimize event participation and thereby increase schedule matches among friends or family members.

According to the present embodiment, the operations of the controller 11 also include collecting second behavior-related information regarding the behavior of the one or more humans in the second geographic area different from the geographic area, extracting a second human parameter from the second behavior-related information, training a second model using the second human parameter, generating one or more second virtual humans using the second model, measuring the behavior of the one or more second virtual humans in the second geographic area, and generating the comparison result by making the comparison between the behavior of the one or more virtual humans in the geographic area and the behavior of the one or more second virtual humans in the second geographic area. With this configuration, the information processing apparatus 1 enables, for example, a city planner to estimate the growth of one of cities and a service provider to estimate the suitability of a service in a new city.

According to the present embodiment, the operations of the controller 11 also include determining, from the comparison result, the service content and the population trend in each of the geographic area and the second geographic area. The operations of the controller 11 include determining, from the comparison result, the number of virtual humans in each of the geographic area and the second geographic area. With this configuration, the information processing apparatus 1 enables a service provider to effectively plan a service.

While the present disclosure has been described with reference to the drawings and examples, it should be noted that various modifications and revisions may be implemented by those skilled in the art based on the present disclosure. Other modifications can be made without departing from the spirit of the present disclosure. For example, functions or the like included in each means or each step can be rearranged without logical inconsistency, and a plurality of means or steps can be combined into one or divided.

For example, in the aforementioned embodiment, a program configured to execute all or some of the functions or processing of the information processing apparatus 1 can be recorded on a computer readable recording medium. The computer readable recording medium includes a non-transitory computer readable medium and is, for example, a magnetic recording apparatus, an optical disc, a magneto-optical recording medium, or a semiconductor memory. The program is distributed, for example, by selling, transferring, or lending a portable recording medium such as a Digital Versatile Disc (DVD) or a Compact Disc Read Only Memory (CD-ROM) on which the program is recorded. The program may also be distributed by storing the program in a storage of any server and transmitting the program from the server to another computer. The program may be provided as a program product. The present disclosure can also be implemented as a program executable by a processor.

Examples of some embodiments of the present disclosure are described below. However, it should be noted that the embodiments of the present disclosure are not limited to these examples.

[Appendix 1] An information processing apparatus comprising a controller configured to execute operations, the operations comprising:
collecting behavior-related information regarding behavior of one or more humans in a certain geographic area;
extracting a human parameter from the behavior-related information;
training a model using the human parameter;
generating one or more virtual humans using the model;
measuring behavior of the one or more virtual humans in the geographic area; and
determining, from the measured behavior, a service content in the geographic area.

[Appendix 2] The information processing apparatus according to appendix 1, wherein the behavior-related information includes psychographic data, demographic data, calendar, health data, an exercise frequency, a purchase pattern, an accompanying human, and/or a family structure.

[Appendix 3] The information processing apparatus according to appendix 1 or 2, wherein the human parameter includes personality, likes/dislikes, a sense of values, activeness, sociability, and/or a hobby.

[Appendix 4] The information processing apparatus according to any one of appendices 1 to 3, wherein the service content relates to transportation, an educational content, a restaurant guide, a meal service, and/or an event.

[Appendix 5] The information processing apparatus according to any one of appendices 1 to 4, the operations comprise:
collecting second behavior-related information regarding behavior of one or more humans in a second geographic area different from the geographic area;
extracting a second human parameter from the second behavior-related information;
training a second model using the second human parameter;
generating one or more second virtual humans using the second model;
measuring behavior of the one or more second virtual humans in the second geographic area; and
generating a comparison result by making a comparison between the behavior of the one or more virtual humans in the geographic area and the behavior of the one or more second virtual humans in the second geographic area.

[Appendix 6] The information processing apparatus according to appendix 5, wherein the operations comprise determining, from the comparison result, a service content and a population trend in each of the geographic area and the second geographic area.

[Appendix 7] The information processing apparatus according to appendix 5, wherein the operations comprise determining, from the comparison result, a number of the virtual humans in each of the geographic area and the second geographic area.

[Appendix 8] An information processing method by an information processing apparatus, the information processing method comprising:
collecting behavior-related information regarding behavior of one or more humans in a certain geographic area;
extracting a human parameter from the behavior-related information;
training a model using the human parameter;
generating one or more virtual humans using the model;
measuring behavior of the one or more virtual humans in the geographic area; and
determining, from the measured behavior, a service content in the geographic area.

[Appendix 9] A program configured to cause a computer to function as the information processing apparatus according to appendix 1.

1. An information processing apparatus comprising a controller configured to execute operations, the operations comprising:
collecting behavior-related information regarding behavior of one or more humans in a certain geographic area;
extracting a human parameter from the behavior-related information;
training a model using the human parameter;
generating one or more virtual humans using the model;
measuring behavior of the one or more virtual humans in the geographic area; and
determining, from the measured behavior, a service content in the geographic area.

2. The information processing apparatus according to claim 1, wherein the behavior-related information includes psychographic data, demographic data, calendar, health data, an exercise frequency, a purchase pattern, an accompanying human, and/or a family structure.

3. The information processing apparatus according to claim 1, wherein the human parameter includes personality, likes/dislikes, a sense of values, activeness, sociability, and/or a hobby.

4. The information processing apparatus according to claim 1, wherein the service content relates to transportation, an educational content, a restaurant guide, a meal service, and/or an event.

5. The information processing apparatus according to claim 1, the operations comprise:
collecting second behavior-related information regarding behavior of one or more humans in a second geographic area different from the geographic area;
extracting a second human parameter from the second behavior-related information;
training a second model using the second human parameter;
generating one or more second virtual humans using the second model;
measuring behavior of the one or more second virtual humans in the second geographic area; and
generating a comparison result by making a comparison between the behavior of the one or more virtual humans in the geographic area and the behavior of the one or more second virtual humans in the second geographic area.

6. The information processing apparatus according to claim 5, wherein the operations comprise determining, from the comparison result, a service content and a population trend in each of the geographic area and the second geographic area.

7. The information processing apparatus according to claim 5, wherein the operations comprise determining, from the comparison result, a number of the virtual humans in each of the geographic area and the second geographic area.

8. An information processing method by an information processing apparatus, the information processing method comprising:
collecting behavior-related information regarding behavior of one or more humans in a certain geographic area;
extracting a human parameter from the behavior-related information;
training a model using the human parameter;
generating one or more virtual humans using the model;
measuring behavior of the one or more virtual humans in the geographic area; and
determining, from the measured behavior, a service content in the geographic area.

9. A non-transitory computer readable medium storing a program configured to cause a computer to function as the information processing apparatus according to claim 1.
